(19) United States
(12) Patent Application Publication
(10) Pub. No.: US 2005/0044761 A1
(43) Pub. Date: Mar. 3, 2005

(54) Telltail Flag

(76) Inventor: Albert Heunglam Chan, Sunnyvale, CA (US)

Correspondence Address: PURPLE FLAX;ALBERT H. CHAN, 982 EAST EVELYN AVE, SUNNYVALE, CA, 94086, US

(21) Appl. No.: 10/605,003

(22) Filed: Aug. 29, 2003

(51) Int. Cl. G09F 21/02

(52) U.S. Cl. 40/586

(57) ABSTRACT

A flag that tells what a queue line is for, and signals the end of the line, by being passed from person to person down to the last person in line.

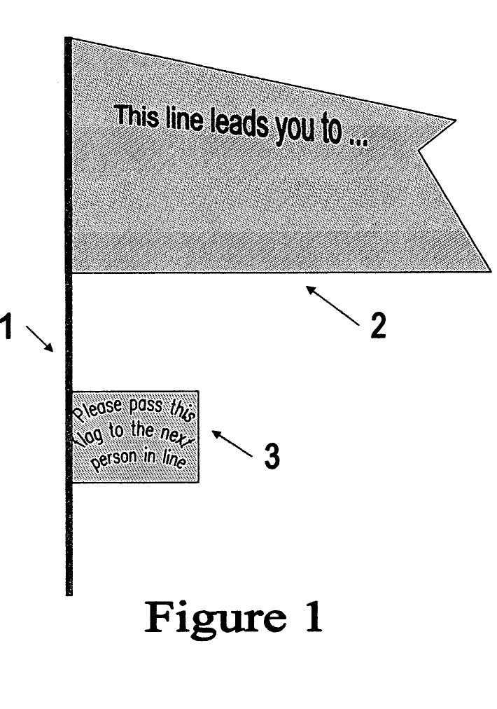

It is a flag to be held by the last person of a queue line. On the flag (2) is a statement that says: “This line leads you to:”, and followed by a title that indicates what the queue line is for. (Title example: “American Airlines Check-in”) On the flagpole (1) there is a small tag (3) on which an instruction is inscribed: “Please pass this flag to the next person in line.” Consequently, the flag is passed from one person to another down the line. Or, to put it in another way, it is always in the hand of the newest member of the line. It serves as a dynamic sign that moves with the length of the line.

There are 3 purposes of Telltail Flag: (A) To tell the people near the end of a long queue line what the line is for, without having to ask around or walk all the way to the beginning of the line to find out. (B) To signal the end of the queue line, which as a result can easily be seen from afar. (C) To indicate who is at the end of the line and who is not. Cutting in line can be avoided simply by passing the flag from one person to another. People not in the line but standing near the end of the line will no longer be confused as waiting in line.

1. Any hand-held device such as a flag that displays information about a queue line, such as the purpose of the line, with implicit or explicit instructions, such as an attached tag inscribed with texts or diagrams that direct people to pass the device down the queue line, that serves the purpose of a dynamic sign telling people what lies ahead of them if they decide to wait in that line. A dynamic sign means a sign which has no fixed location, but moves along with the length of the queue line and the location of the newest member who joins the line.

2. A hand-held device similar to a flag that displays information about a queue line, with an instructional tag attached to the handle, telling people to pass the device down the queue line.
